(19) United States
(12) Patent Application Publication
(10) Pub. No.: US 2021/0364187 A1
(43) Pub. Date: Nov. 25, 2021

(54) Cover Accessory Apparatus

(71) Applicant: BAM Patents, LLC., Wauwatoda, WI (US)

(72) Inventor: William E. Gridley, Delafield, WI (US)

(73) Assignee: BAM Patents, LLC., Wauwatosa, WI (US)

(21) Appl. No.: 17/327,384

(22) Filed: May 21, 2021

Related U.S. Application Data
(63) Continuation of application No. 29/738,932, filed on Jun. 21, 2020.
(60) Provisional application No. 63/029,452, filed on May 23, 2020.
(60) Provisional application No. 63/048,742, filed on Jul. 7, 2020.

(51) Int. Cl. F24F 11/89

(52) U.S. Cl. CPC F24F 11/89; B60J 9/00

(57) ABSTRACT

Disclosed is a cover accessory device that is configured for being threaded onto a flexible cover designed to cover vehicles (e.g., boats, cars, etc.) or structures (e.g., tents). The cover accessory device may provide any one or all of a venting function, supporting function, and a bling function.

### CLAIM TO PRIORITY

This application claims priority to provisional application 63/029,452 filed on 23 May 2020, provisional application 63/048,742 filed on 7 Jul. 2020, and design patent application Ser. No. 29/738,932 filed on 21 Jun. 2020, of which the entire contents are incorporated herein by this reference for all that they disclose for all purposes.

### TECHNICAL FIELD

Embodiments of the invention relate, in general, to the field of flexible cover accessory apparatuses, and in particular, the utilitarian and ornamental features for a support and/or vent apparatus adapted for use with a flexible cover for covering vehicles (e.g., boats, cars, etc.) or structures (e.g., tents).

### BACKGROUND OF THE INVENTION

Recreational vehicles such as boats and travel trailers are frequently stored outdoors when not in use. Consequently, a cover may be placed over the entire vehicle or a large portion of the vehicle to protect it from elements of its environment such as rain, snow, hail, ultraviolet rays, heat from direct sunlight, and dirt dust from the outside air. In this regard, a simple cover is quite adequate and yet an inexpensive alternative to indoor storage. Such covers can comprise canvas, plastic, and other generally non-porous materials. A non-porous cover functions very well for its intended purpose as neither dirt nor rain can penetrate the non-porous material. As a result, the covered item is reasonably well protected when not in use.

One problem with using a porous or non-porous cover to protect a vehicle is moisture and mildew resulting from condensation and other sources of moisture. For an entirely non-porous cover, the condensation, in the form of moisture, is trapped inside the cover, penetrating every unsealed surface of the covered vehicle and every electrical, mechanical, and fabric component in the vehicle. Indeed, the trapped moisture in a covered vehicle may be more damaging than had the vehicle been left uncovered. An uncovered vehicle can dry out, but a covered vehicle with moisture trapped under the cover does not dry out, and the vehicle is continuously exposed to the moisture, which can cause a significant amount of damage.

Newer, breathable materials allow some of the trapped moisture to escape, but not entirely, and even with the breathable materials, moisture remains trapped inside the cover longer than it would if the cover were removed and the vehicle allowed to air dry. It is to be noted that the moisture problem is not necessarily exclusive to the outdoors. Indeed, indoor storage, for example, where the air is not conditioned or otherwise dry, can experience high humidity. In such an environment, the moist air can damage a covered object or vehicle by becoming trapped under the cover.

In a commonly owned U.S. Patent issued to Gridley (U.S. Pat. No. 6,938,631) on 6 Sep. 2005, the applicant disclosed a new apparatus for venting and supporting a cover covering a vehicle. Such a ventilation apparatus allows air to pass in and out of the space inside of the cover freely. Applicant disclosed an improved apparatus for venting and supporting a cover in U.S. Pat. Nos. 8,069,870 and 8,220,474 issued to Gridley on 6 Dec. 2011 and 17 Jul. 2012. U.S. Pat. Nos. 6,938,631, 8,069,870, and 8,220,474 are hereby incorporated by this reference for all that they disclose for all purposes.

The above designs worked well for their intended purposes, but there was an issue with the design that needed improvement. There was a need to make the cover apparatus easier to associate with a cover. A new solution disclosed in this document was developed after years of testing and reviewing customer feedback.

One should appreciate that all venting apparatus designs require at least one hole through the cover to be associated with the venting/support apparatus. Such often creates a problem with the venting apparatus not fitting to the cover properly, causing the venting/support apparatus to disassociate, at least partially, from the cover under load.

Thus, one of the challenges a designer of cover venting and supporting apparatuses face relates to the method of associating the venting device to the cover. Many of the Applicant's prior designs, described above, use a clamping function to clamp a portion of the cover between plates associated with the venting features. Such was an improvement over previous vent versions where the vent was sewn into the cover as the installation was more manageable and the vent more easily removable.

More recent devices went back to sewable flanges, with some including a snap-fit flange type element to assist in the process of sewing a flange to a cover. However, such a design requires one to cut a hole in the cover big enough to pull over the snap-fit flange and then sew the device to a cover. Such a design is not an optimal solution. Further, attaching such vents to a cover is time-consuming and tedious and requires the knowledge and use of a sewing machine (often a particular kind of sewing machine). Such designs require the vent to be sewn to a cover so that the vent will not fail under load (i.e., the device will become disassociated, at least partly, from the cover). Sewing is required as the cover hole through which the device extends has a slightly smaller diameter than one of the device flanges (the smaller diameter flange one “snaps” the cover over). Thus, the device will simply push through or fall through the cover under load if not sewn.

While a commercial customer may go through the trouble of training employees and buying sewing machines to attach such devices to a cover, a typical private vehicle owner would likely not be willing to do the same. What is needed is a more universal design that gives a user a choice to mechanically associate (sewed, glued, clamped, etc.) the device to a cover, if desired, or to associate the device to a cover without a mechanical association.

The cover accessory apparatus disclosed in this application is a device that does not require sewing (or similar attachment methods) the apparatus to a cover but which does allow for a user to sew the cover accessory apparatus to a cover if desired (for certain embodiments). Further, for some embodiments, no sewing or clamping force is required to maintain the association between the cover accessory apparatus and the cover under load. Thus, the disclosed technology is a more universal design that can be used to securely associate a cover accessory apparatus to a cover by users who use either method.

### SUMMARY OF THE INVENTION

Some of the objects and advantages of the invention will now be set forth in the following description, while other objects and advantages of the invention may be obvious from the description or may be learned through the practice of the invention.

Broadly speaking, a principle object of the present invention is to provide a cover accessory apparatus for a flexible cover such as vehicle cover (e.g., boats, cars, etc.) and structure covers (e.g., tents) that can be threaded through a hole defined by the cover.

Another object of the present invention is to provide a cover accessory apparatus for a cover that provides for a universal design that will provide a venting function, and that can be threaded through a hole and selectively sewn, or not, to a cover while not failing under load using either option.

Yet another object of the present invention is to provide a cover accessory apparatus and method that provides a venting/supporting function to a cover where the cover accessory apparatus is further configured to receive a top element where the top element may be selected from a plurality of designs.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps or features hereof may be practiced in various uses and embodiments of this invention without departing from the spirit and scope thereof, by virtue of the present reference thereto. Such variations may include, but are not limited to, the substitution of equivalent steps, referenced or discussed, and the functional, operational, or positional reversal of various features, steps, parts, or the like. Still, further, it is to be understood that different embodiments, as well as different presently preferred embodiments, of this invention, may include various combinations or configurations of presently disclosed features or elements, or their equivalents (including combinations of features or parts or configurations thereof not expressly shown in the figures or stated in the detailed description). Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a side elevation view of an assembled cover accessory apparatus comprising a top element associated with a cover material;

FIG. 2 is a side elevation view of an assembled embodiment of the cover accessory apparatus in FIG. 1 with a top element defining a suspension interface;

FIG. 3 is a perspective view of a cover accessory apparatus base with the top element removed and a flange gap defined by a first flange;

FIG. 4 is a top plan view of the base element depicted in FIG. 3;

FIG. 5 is a bottom plan view of the base element depicted in FIG. 3;

FIG. 6 is a front elevation view of the base element depicted in FIG. 3;

FIG. 7 is a back elevation view of the base element depicted in FIG. 3;

FIG. 8 is a left side elevation view of the base element depicted in FIG. 3;

FIG. 9 is a right side elevation view of the base element depicted in FIG. 3;

FIG. 10 is a side elevation view of one embodiment of a cover accessory apparatus with a flange gap defined by a second flange;

FIG. 11 is a side elevation view of a top element;

FIG. 12 is a top plan view of the top element depicted in FIG. 11;

FIG. 13 is a bottom plan view of the top element depicted in FIG. 12;

FIG. 14 is a side elevation of a top element defining a suspension interface;

FIG. 15 is a top plan view of the top element depicted in FIG. 14;

FIG. 16 is a bottom plan view of the top element depicted in FIG. 15;

FIG. 17 is a perspective view of an embodiment of a cover accessory apparatus having a base element with a flange defining two flange gaps;

FIG. 18 is a top plan view of the base element depicted in FIG. 17;

FIG. 19 is a bottom plan view of the base element depicted in FIG. 17;

FIG. 20 is a front elevation view of the base element depicted in FIG. 17; and

FIG. 21 is a back elevation view of the base element depicted in FIG. 17.

FIG. 22 is a right side elevation view of the base element depicted in FIG. 17; and

FIG. 23 is a right side elevation view of the base element depicted in FIG. 17.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements, or steps. It is to be understood by one of ordinary skill in the art that the present discussion is a description of exemplary embodiments only, and is not intended as limiting the broader aspects of the present invention.

### Construction Aids

For the purposes of this document, two or more items are “mechanically associated” by bringing them together or into a relationship with each other in any number of ways, including “releasable connections,” “hard connections,” and “moveable connections.” A “releasable connection” is a direct or indirect physical connection designed to be easily and frequently released and reconnected, including connections achieved using snaps, screws, Velcro®, bolts, clamps, to name a few. A “hard-connection” is a connection that one does not anticipate disconnecting very often, if at all, and generally must be “broken” to separate and includes welds, rivets, sewing, macular bonds, to name a few. A “moveable connection” is simply a connection that allows some movement between the connected components (rotating, pivoting, oscillating, etc.).

Similarly, two or more items are “electrically associated” by bringing them together or into a relationship with each other in any number of ways, including: (a) a direct, indirect, or inductive communication connection and (b) a direct/indirect or inductive power connection. A communication connection may be wireless or wired unless otherwise stated. Additionally, while the drawings may illustrate various electronic components of a system connected by a single line, it will be appreciated that such lines may represent one or more signal paths, power connections, electrical connections and/or cables as required by the embodiment of interest.

As used herein, the terms “first,” “second,” and “third” may be used interchangeably to distinguish one component from another and are not intended to signify the location or importance of the individual components.

The term “axial” refers to a direction parallel to the direction of rotation of an object; the term “radial” refers to a direction extending away from the center of an object or normal to the “axial” direction, and the term “circumferential” refers to a direction extending around the circumference or perimeter of an object.

As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

In this document, unless otherwise stated, the phrase “at least one of A, B, and C” or “one of A, B, and C” means there is at least one of A, or at least one of B, or at least one of C or any combination thereof. Such does not mean one of A, and one of B, and one of C.

Any two polygons are similar if their corresponding angles are congruent, and the measures of their corresponding sides are proportional. Similar polygons have the same shape but can be different sizes. For the purpose of this document, circles are polygons.

For this document, a flexible cover is a cover made from any suitable material for forming a flexible cover to protect items from their environment. Examples of flexible covers include tarpaulins or tarps, such as the ones used to make covers for vehicles such as boats and automobiles, and the materials used to make tents.

For this document, with regard to the cover accessory apparatus, a “rigid” material includes materials such as polycarbonate, Acrylonitrile Butadiene Styrene (ABS plastic), Acrylonitrile Styrene Acrylate (ASA plastic), and Nylon. Rigid materials are considered rigid if they are not suitable for sewing using standard industrial sewing machines. An example of a “flexible” material, with regard to the various elements of the cover accessory apparatus, is Thermoplastic Polyurethane (TPU), which is sewable.

This document includes headers that are used for place markers only. Such headers are not meant to affect the construction of this document; do not in any way related to the meaning of this document, nor should such headers be used for such purposes.

### DESCRIPTION

While the particulars of the present invention and associated technology may be described as a vent/support apparatus for a flexible cover (such as canvas) associated with a vehicle, the invention may be adapted for any similar purpose, including venting/supporting a tent or other structures associated with a flexible cover.

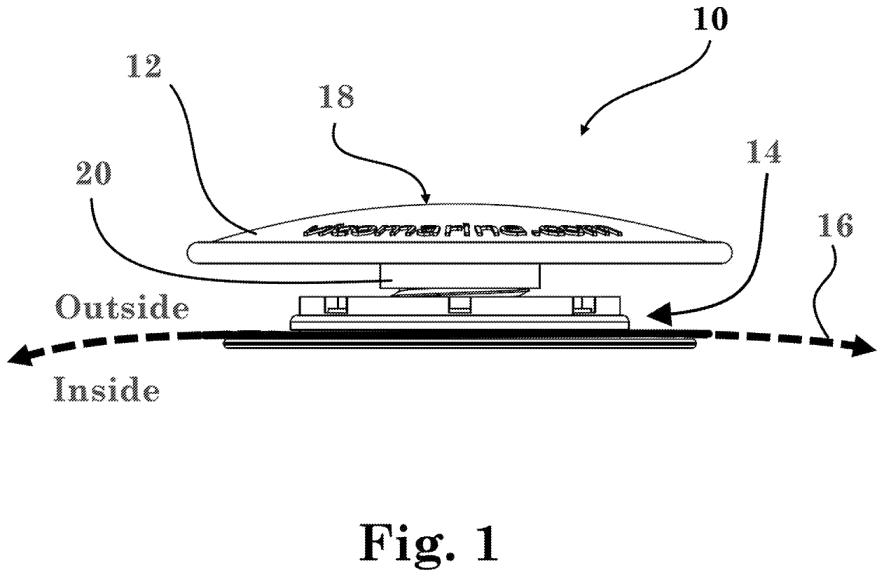

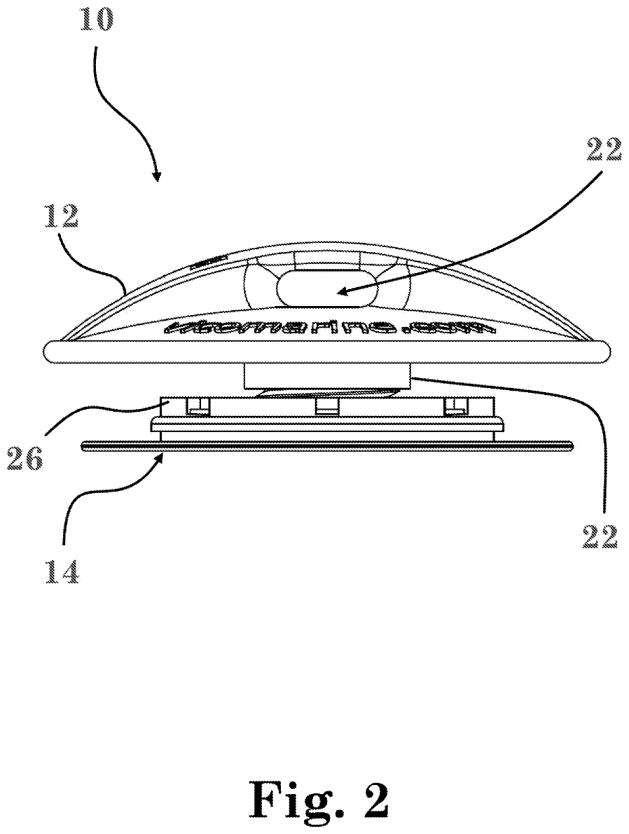

Referring now more particularly to FIG. 1 and FIG. 2, presented is a side elevational view of an assembled cover accessory apparatus 10 comprising an optional top element 12 releasably associated with a base element 14 associated with a flexible cover 16. As can be seen in FIG. 1, the cover accessory apparatus 10 is associated with a flexible cover 16 so that the top element 12 and a portion of the base element 14 is disposed above the flexible cover 16 (referred to as the “outside”). Similarly, a portion of the base element 14 is also disposed below the flexible cover 16 (referred to as the “inside”). Thus, at least part of the cover accessory apparatus 10 extends through a hole in the flexible cover 16.

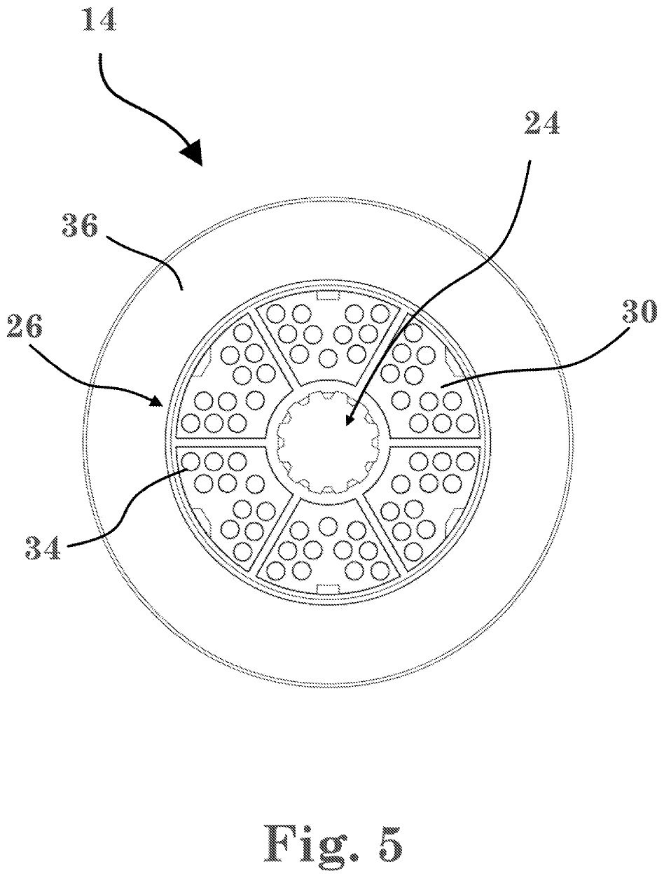

The top element 12 defines a dome portion 18 configured to at least partially cover the base element 14. At the center of the dome portion 18 is a depending base 20 that may extend perpendicularly away from the dome and is configured for being releasably associating with the base element 14 (as described in more detail later). In FIG. 2, an alternative embodiment for a top element 12 is presented, defining a suspension interface 22 configured for receiving a suspension element (not shown). A suspension element is any element (e.g., rope, chain, cable, etc.) that can be attached to the suspension interface 22 to support the cover accessory apparatus 10 and associated flexible cover 16. Similarly, as best seen in FIG. 5, the cover accessory apparatus 10 may also define a support structure interface 24 configured for receiving a support element such as a pole (not shown).

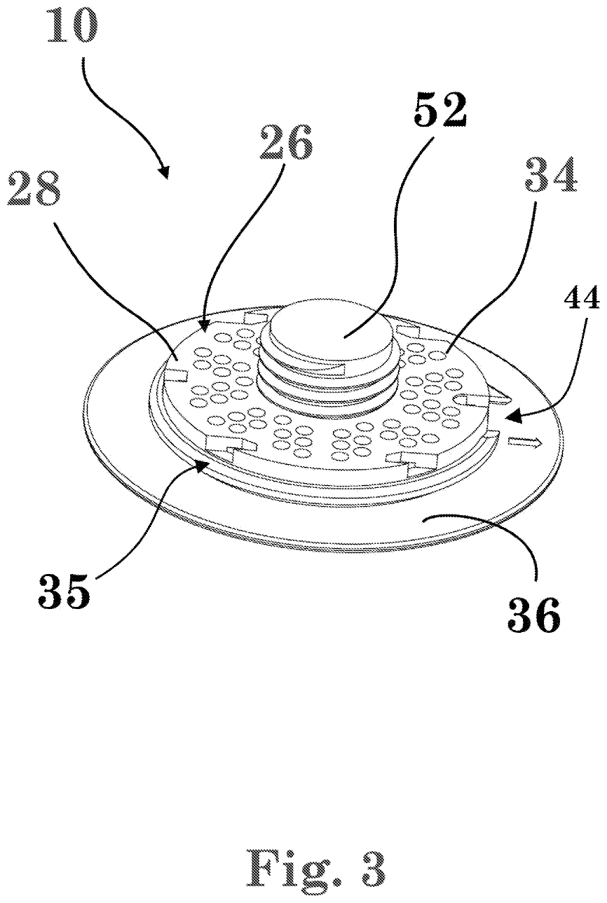

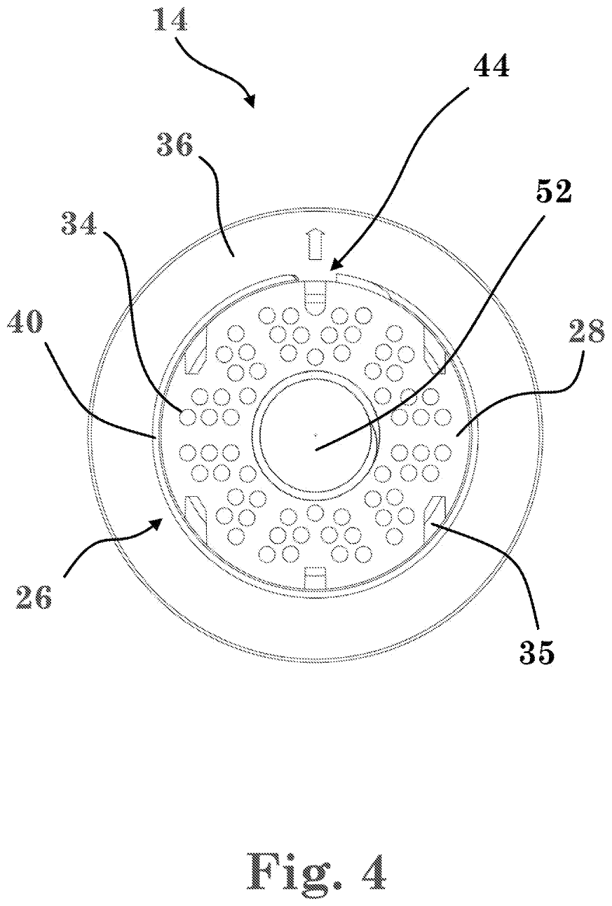

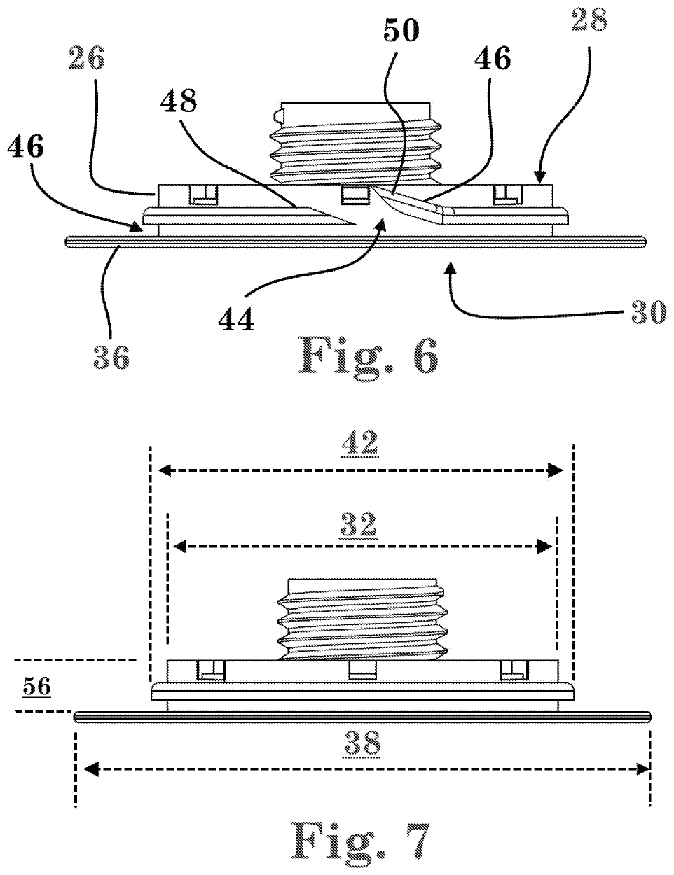

Referring now more particularly to FIG. 3 through FIG. 7, embodiments of a cover accessory apparatus 10 without the optional top element 12 are considered in more detail. The cover accessory apparatus 10 comprises a hub 26, defining a hub body comprising a first hub end 28 and an opposing second hub end 30. The outer perimeter of the hub 26 defines a circle defining a hub diameter 32, as depicted in FIG. 7. It should be appreciated, however, that the hub 26 outer perimeter may define any suitable polygonal shape. As best seen in FIGS. 4 and 5, the hub 26 may define at least one hub void 34 that extends from the first hub end 28 to the second hub end 30. One of ordinary skill in the art will appreciate that such hub void 34 will allow air to pass through the hub 26 from inside the cover 16 to outside the cover 16 (and vice versa). Notably, for the embodiment depicted in FIG. 4, the hub 26 defines a plurality of hub voids 34 disposed around the center of the hub 26. In addition, a plurality of directional void slots 35 may be defined along the outer perimeter of hub 26 configured to enhance the air exchange between the inside of cover 16 and the outside of cover 16 when the air is hoving horizontal relative to the hub 26 (e.g., wind blowing or the cover 16 is in motion). One of ordinary skill in the art will appreciate that the directional void slots 35 provide for both a horizontal opening as well as a vertical opening relative to the vertical axis of the hub 26.

The cover accessory apparatus 10 further comprises a first flange 36 extending annularly around the hub body and extending radially away from the hub body, thereby defining a first flange diameter 38 (FIG. 7) that is longer than the hub diameter 32. The first flange 36 may be disposed closer to the second hub end 30 than the first hub end 28. For the current embodiment, the first flange 36 extends from the hub body at the second hub end 30, as depicted in FIG. 3 through FIG. 7.

The cover accessory apparatus 10 further comprises a second flange 40 that extends annularly around the hub body and radially away from the hub body, thereby defining a second flange diameter 42, as depicted in FIG. 7. The second flange diameter 42 is longer than the hub diameter 32 and may be equal to, longer than or shorter than the first flange diameter 38. For the current embodiment, the second flange diameter 42 is shorter than the first flange diameter. Further, the second flange 40 is disposed closer to the first hub end 28 than the second hub end 30. Restated, the second flange 40 may be disposed between the first hub end 28 and the first flange 36. As discussed below, for this embodiment, the second flange 42 defines a flange gap 44.

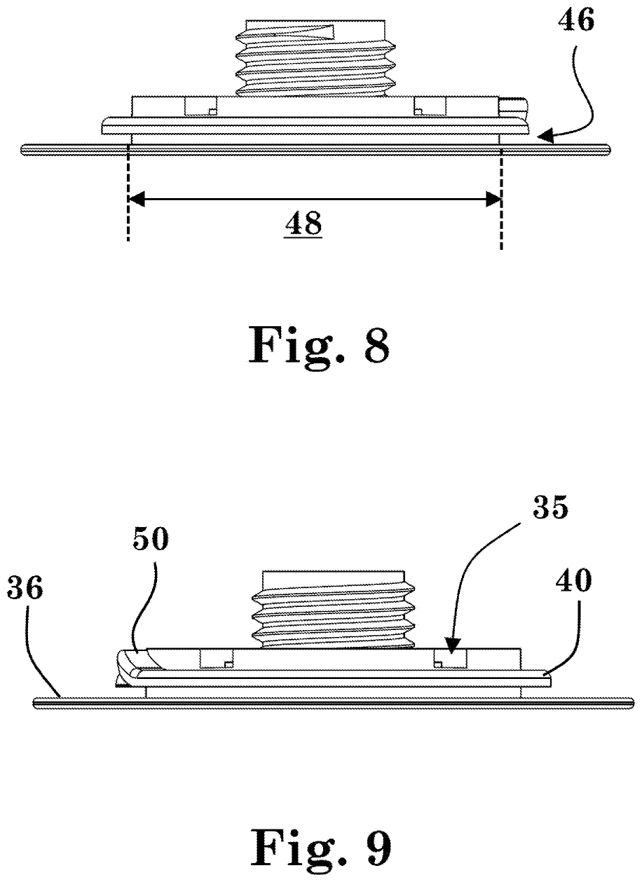

The cover accessory apparatus 10 may further comprise a cover interface 46 defined between the first flange 36 and the second flange 38 and defining an inside cover interface diameter 48 (FIG. 8). The inside cover interface diameter 48 may be equal to, longer than, or shorter than the hub diameter 32. For the current embodiment, the inside cover interface diameter 48 is equal to the hub diameter 32. It should be further appreciated that the first flange diameter 38 and the second flange diameter 42 are longer than the inside cover interface diameter 48.

To provide for the threading of the cover accessory apparatus 10 to the cover 16 as described above and below, at least one flange gap 44 may be defined by at least one of the first flange 36 or the second flange 40, thereby defining at least one discontinuous flange (i.e., at least part of the flange does not extend entirely around the hub body). The flange gap 44 may be configured to allow a flexible cover 16 defining a cover hole with a hole diameter shorter than the first flange diameter 38 and the second flange diameter 42 to be threaded into the cover interface, thereby associating the cover accessory apparatus 10 with the flexible cover 16.

Ideally, the diameter of the hole defined by the flexible cover 16 is slightly shorter than the inside cover interface diameter 48 to provide for a more secure fitment. For example, the flexible cover 16 may define a hole having a diameter that is X units shorter than the inside cover interface diameter 48, where X is the length of the gap between the first flange and the second flange. Notably, as mentioned above, the inside cover interface diameter 48 may or may not be equal in length to hub diameter 32.

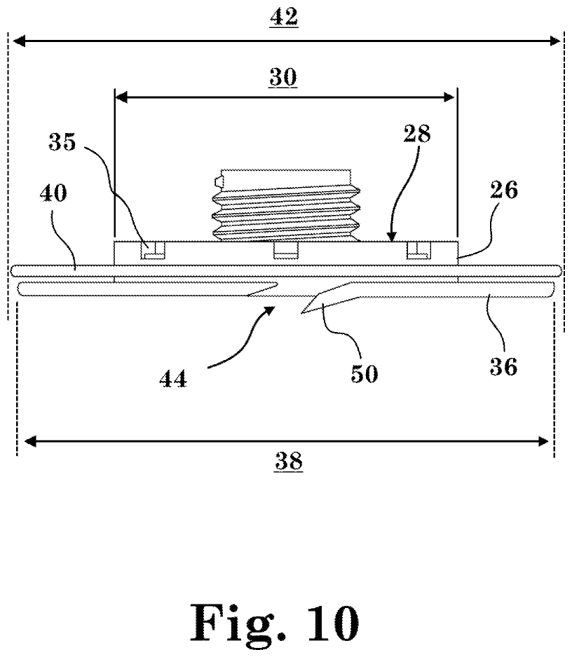

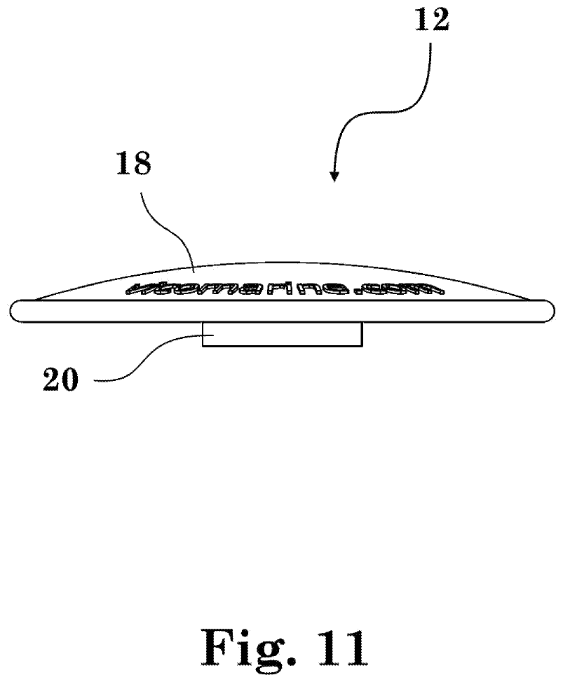

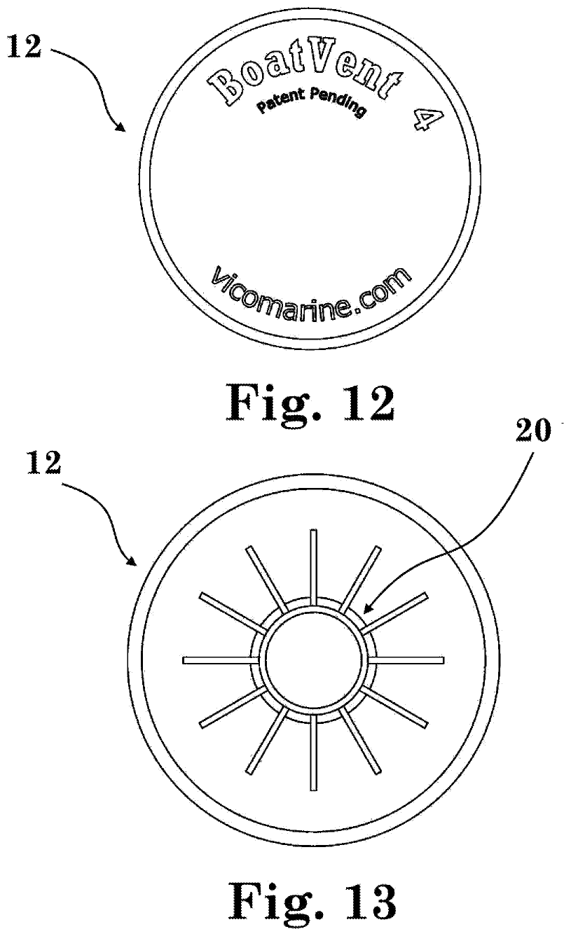

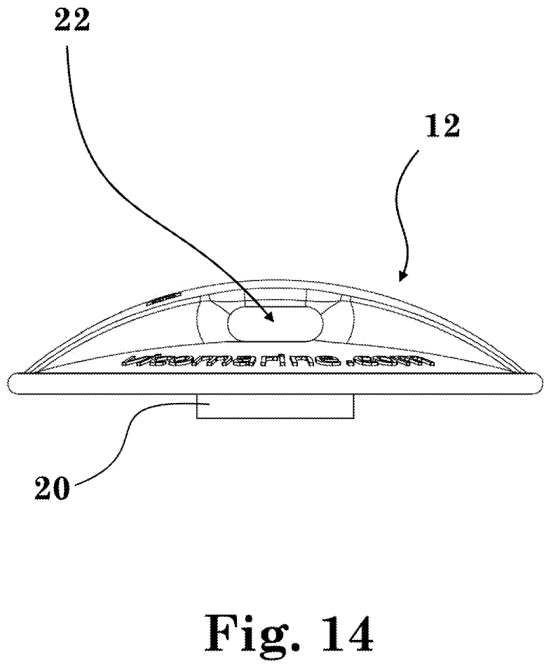

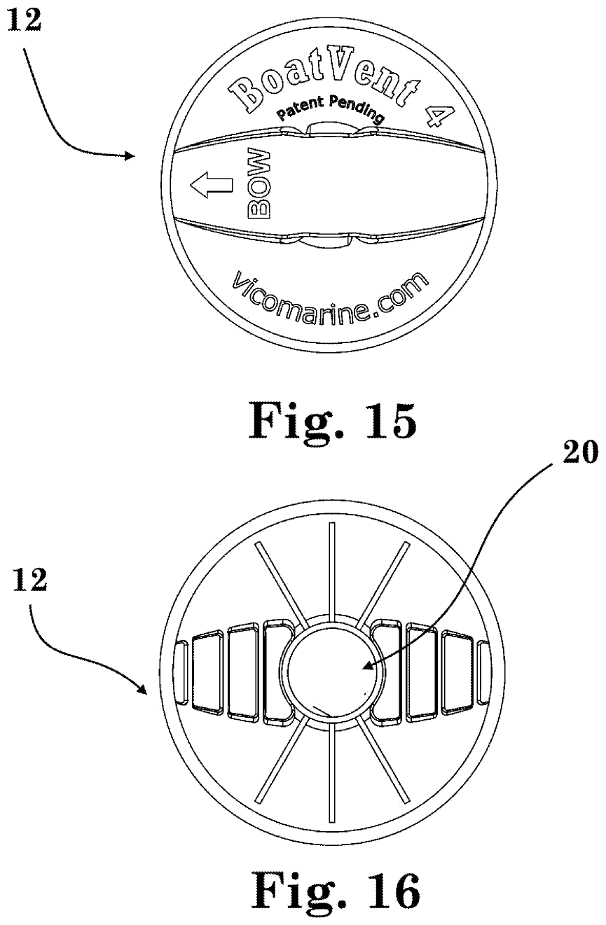

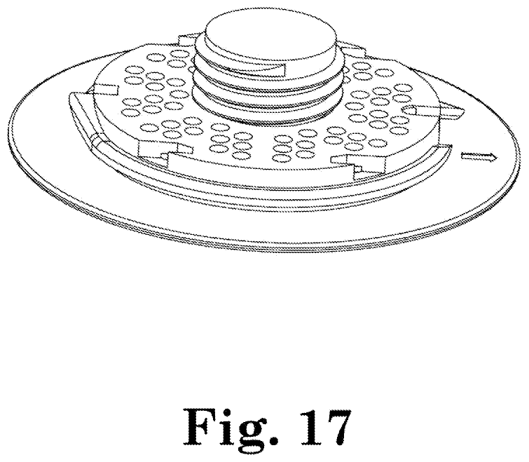

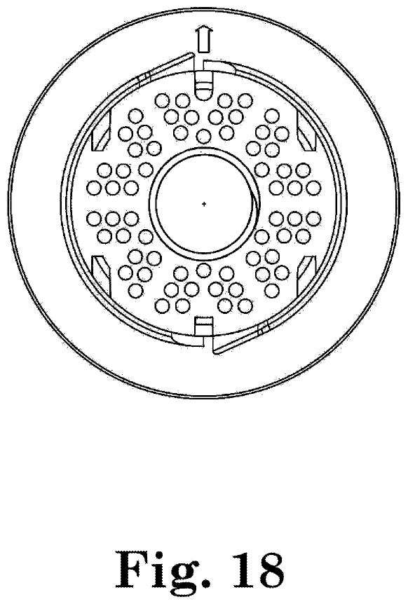

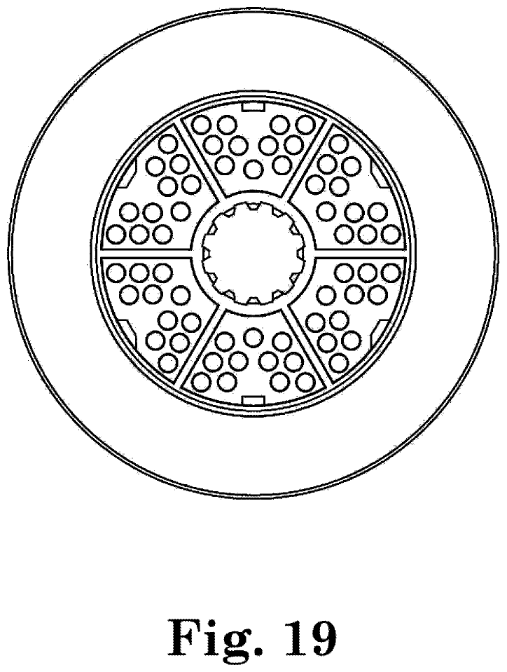

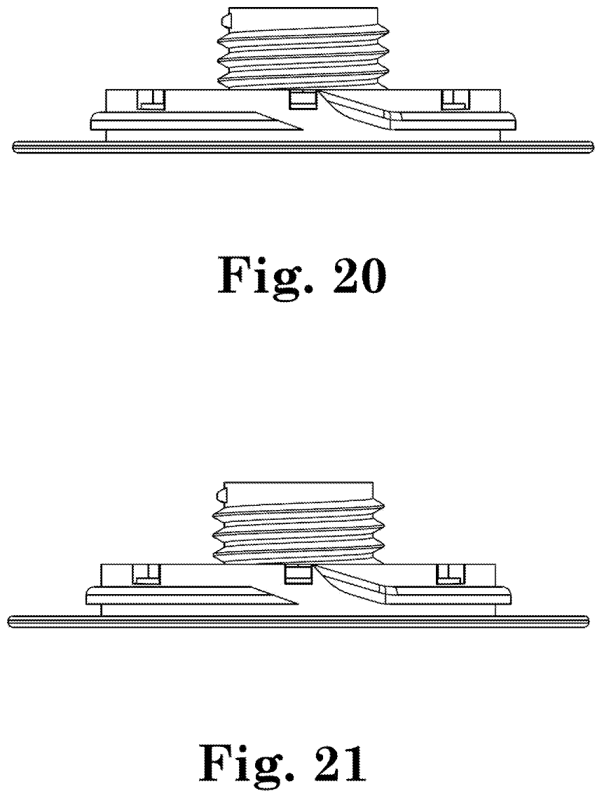

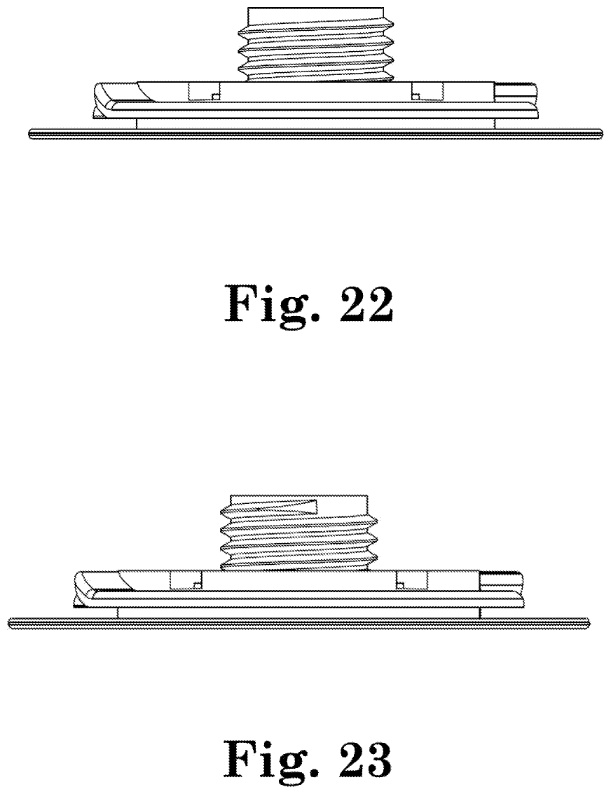

As depicted in FIG. 10, the first flange 36 may define a flange gap 44, and the first flange diameter 38 may be shorter than the second flange diameter 42. Further, both flanges may define a flange gap 44. At least one of the flange gaps 44 may define a gap finger 50, which may be configured to help guide the cover 16 into the cover interface 46 as the cover accessory apparatus 10 is threaded to the flexible cover 16.

### Top Element

As can be seen in FIG. 3, for some embodiments of the base element 14, the first end 26 defines a top element receiver 52 configured for receiving a top element 12. As noted above and as depicted in the figures, a top element 12 defines a dome portion 18 configured to at least partially cover the base element 14. At the center of the dome portion 18 is a depending base 20 that may extend perpendicularly away from the dome and is configured for being releasably associating with the base element 14.

For the most basic cover accessory apparatus 10 configuration, the first end 46 of hub 26 does not include a top element receiver 52. When a top element receiver 52 is provided, it may be a threaded part configured to thread to a top element 12, or an unthreaded part configured to be glued to a top element 12 or mechanically associated with a top element 12 using some other suitable method. Alternatively, the first end 46 may define a female threaded hole configured to receive a male threaded stud defined by a top element 12.

For the embodiment depicted in FIG. 3, the top element receiver is a male threaded stud configured for threading into the depending base 20. Such a configuration allows for any number of top element 12 modules to be developed by the OEM or third parties. For the top element 12 depicted in FIG. 1, the top element 12 defines an umbrella function that covers the hub voids 34 and directional void slots 35 defined by hub 26. The top element 12 depicted in FIG. 2 not only provides such an umbrella function but also provides a suspension interface 22. Electronic-based top elements 12 may be developed, including top elements associated with photovoltaic chargers connected to a lighting element that provides light at night. The light could also be associated with an accelerometer where the light is activated when acceleration above a certain level is detected, perhaps to provide a brake light function.

Similarly, for the most basic cover accessory apparatus 10, the second hub end 30 may not define a support structure interface 24, as depicted in FIG. 5. Such a support structure interface 24, when provided, is configured to receive a support structure such as one end of a pole. The other end of such pole is associated with a support surface, thereby supporting the cover accessory apparatus 10 and any associated cover 16 from below.

For one embodiment, the cover interface 46 may define a hub channel 60 along the hub side of the cover interface 46. It should be appreciated that the cover interface 46 comprises a portion of the surface of the first flange 36 and a portion of the surface of the second flange 40 and a portion of the hub body disposed between the first flange 36 and the second flange 40. The optional hub channel 60 may be defined along a portion of the hub body disposed between the first flange 36 and the second flange 40. If a hub channel 60 is provided, it may be disposed 180 degrees from the flange gap 44 to provide more “mercy” (slack, wiggle room, etc.) while rotating the hub 26 to feed the cover into the cover interface 46.

### Exemplary Apparatus Dimensions

The term “about” for apparatus 10 dimensions means plus or minus 10%. It should be appreciated by one of ordinary skill in the art that any size cover accessory apparatus 10 can be constructed with the disclosed inventive/novel features. Exemplary cover accessory apparatus 10 dimensions are now considered for covers 16 of the size that are typically associated with boats (for example) that a user transports on a boat trailer.

The distance from the first hub end 28 and the second hub end 30 (hub height 56) may be about 10 mm. The hub diameter 32 may be about 70 mm to 80 mm. Generally, the hub diameter 32 is the same along the entire hub 26. However, it should be appreciated that the hub 26 diameter above the second flange 40 may be different from the hub 26 diameter below the second flange 40. Such may allow for easier threading of the universal cover accessory apparatus 10 to a cover 16.

The first flange diameter 38 may vary from about 90 mm to about 130 mm and will generally be around 116 mm for the cover size described above. Similarly, the second flange diameter 42 may vary from about 75 mm to about 130 mm. That said, the second flange diameter 42 should be equal to or shorter than the first flange diameter 38 and longer than the inside cover interface diameter 54. The cover interface 46 is defined between the second flange 40 and first flange 36, and the associated gap distance may be about 2.2 mm. Such gap distance may be varied based on the thickness of the flexible cover 16 to be associated with the cover accessory apparatus 10. The cover interface 46 defines an inside cover interface diameter 48 between about 70 mm to about 80 mm, and such diameter may be equal to the hub diameter 32. Notably, the diameter of the cover 16 hole through which the cover accessory apparatus 10 will be threaded is desirably slightly shorter than the inside cover interface diameter 48. For such a configuration, once the cover accessory apparatus 10 is threaded through the cover 16 hole, the apparatus 10 should not fail under load even where the apparatus 10 is not mechanically associated (e.g., clamped, glued, sewn, etc.) with the cover 16.

A typical first flange 36 thickness may be about 2 mm, and a typical second flange 40 thickness may be about 5 mm.

While exemplary feature dimensions are given above for the size cover that is generally used to cover a boat that can be transported on a trailer, any size apparatus 10 may be constructed using the inventive/novel features described above by maintaining the relative dimensions taught above. Such relative dimensions include a first flange diameter 38 that may be equal to or longer than the second flange diameter 42. The second flange diameter 42 may be equal to or shorter than the first flange diameter 38 and longer than inside cover interface diameter 54.

### Threading Apparatus to Cover

As noted above, the cover accessory apparatus 10 is associated with a flexible cover 16 by threading the cover accessory apparatus 10 onto the flexible cover 16 through a hole defined by flexible cover 16. The cover 16 hole diameter is to be slightly less (about 4 mm less for the above example) than the inside cover interface diameter 48. The second flange diameter 42 should be longer than the inside cover interface diameter 48 by at least ten percent or by the amount needed to prevent a flexible cover 16 from stretching over the second flange 40 under load. The method of threading the cover accessory apparatus 10 to a cover 16 will depend on which flange defines a flange gap, and where both flanges define a flange gap, the flange gap selected.

If a top element 12 is present, the top element 12 is removed from the base element 14. Where the second flange 40 defines the flange gap 44, the base element 14 is inserted through a hole defined by a cover 16 from the inside of the cover 16 so that an edge of such cover hole is in the flange gap 44, and the approximate center of the hub 26 is at the approximate center of the hole. The hub is rotated so that the edges of the cover hole are fed (threaded) into the cover interface 46 until the entire perimeter of the cover hole is associated with the cover interface 46.

If the apparatus 10 is made of flexible material, the first flange 36 may be optionally sewed to the cover 16 for additional structural support. Other methods of adding extra structural support may be to glue the cover in the cover interface 46 or use a mechanical circlip type device that clamps around the cover within the cover interface 46.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cover accessory apparatus configured for being associated with a flexible cover, said cover accessory apparatus comprising:
a hub defining a hub body defining a hub diameter and comprising a first hub end and an opposing second hub end;
at least one vent void extending from said first hub end to said second hub end;
a first flange extending annularly around the hub body and extending radially away from the hub body, thereby defining a first flange diameter that is longer than the hub diameter and wherein said first flange is disposed closer to the second hub end than the first hub end;
a second flange extending annularly around said hub body and extending radially away from said hub body, thereby defining a second flange diameter that is longer than the hub diameter, and wherein said second flange is disposed between the first hub end and said first flange;
a cover interface defined between said first flange and said second flange and defining an inside cover interface diameter;
a flange gap defined by at least one of said first flange or said second flange, thereby defining at least one discontinuous flange wherein said first flange diameter and said second flange diameter is longer than said inside cover interface diameter and wherein the flange gap is configured to allow a flexible cover defining a cover hole smaller than said first flange diameter and said second flange diameter to be threaded into the cover interface thereby associating said cover accessory with the flexible cover.

2. A cover accessory apparatus as in claim 1, wherein said cover accessory apparatus is constructed from a rigid material.

3. A cover accessory apparatus as in claim 1, wherein said second flange diameter is shorter than said first flange diameter and wherein said first flange is constructed from a flexible material that allows the sewing of the cover to said first flange, thereby defining a universal cover accessory apparatus.

4. A cover accessory apparatus as in claim 1, where said second hub end defines a support structure interface configured to receive a support structure and wherein said first hub end defines a top element receiver configured for releasably receiving a top element.

5. A cover accessory apparatus as in claim 1, wherein said flange gap defines a guide finger.

6. A cover accessory apparatus as in claim 1, wherein the second flange diameter is between about 1 percent to about 20 percent shorter than the first flange diameter and wherein said flange gap is defined by said second flange.

7. A cover accessory apparatus as in claim 6, wherein said second flange defines two second flange gaps disposed around said hub body about 180 degrees apart.

8. A cover accessory apparatus as in claim 6, where the diameter of the hub body above said second flange is shorter than the diameter of the hub body below said second flange.

9. A cover accessory apparatus as in claim 6, further comprising a hub channel that extends annularly around said hub within said cover interface.

10. A cover accessory apparatus as in claim 1, wherein said first flange diameter is shorter than said second flange diameter and wherein said first flange defines said flange gap.

11. A cover accessory apparatus as in claim 10, where said first hub end defines a top element receiver configured for releasably receiving a top element.

12. A cover accessory apparatus as in claim 10, wherein said flange gap defines a guide finger.

13. A cover accessory apparatus configured for being associated with a flexible cover, said cover accessory apparatus comprising:
a hub defining a hub body defining hub diameter and comprising a first hub end and an opposing second hub end;
a first flange disposed one of at the second hub end or between the second hub end and the first hub end and wherein said first flange extends annularly around the hub body and extends radially away from the hub body thereby defining a first flange diameter that is longer than the hub diameter;
a second flange disposed between said first flange and the first hub end and extending annularly around said hub body and extending radially away from said hub body thereby defining a second flange diameter that is longer than the hub diameter
a cover interface defined between said first flange and said second flange and defining a cover interface inside diameter; and
a flange gap defined by at least one of said first flange or said second flange thereby defining at least one discontinuous flange and wherein said flange gap is configured to allow a flexible cover defining a cover hole with a diameter shorter than the diameter of the flange defining said flange gap to be threaded into the cover interface thereby associating said cover accessory apparatus with the flexible cover.

14. A cover accessory apparatus as in claim 13, wherein said cover accessory apparatus is constructed from a rigid material.

15. A cover accessory apparatus as in claim 13, wherein said hub body further defines at least one of (a) at least one vent void extending from the first hub end to the second hub end or (b) a support structure interface at said second hub end.

16. A cover accessory apparatus as in claim 13, wherein said hub further comprising a top element receiver defined at said first hub end and configured for releasably receiving a top element.

17. A cover accessory apparatus as in claim 13, wherein said second flange gap defines a guide finger.

18. A cover accessory apparatus as in claim 13, wherein said second flange diameter is between about 1 percent to about 20 percent shorter than said first flange diameter.
